(19) United States
(12) Patent Application Publication
(10) Pub. No.: US 2025/0174152 A1
(43) Pub. Date: May 29, 2025

(54) ADAPTIVE PHONICS INSTRUCTION USING PHONEME-GRAPHEME MAPPING AND DYNAMIC CONTENT GENERATION

(71) Applicant: ILLUMINATIONS, LLC, Meridian, MS (US)

(72) Inventor: Leta Palmiter, Meridian, MS (US)

(21) Appl. No.: 18/960,700

(22) Filed: Nov. 26, 2024

Related U.S. Application Data
(60) Provisional application No. 63/604,066, filed on Nov. 29, 2023.

(51) Int. Cl. G09B 19/04; G09B 5/06

(52) U.S. Cl. CPC G09B 19/04; G09B 5/06

(57) ABSTRACT

An individualized decodable text system and non-transitory computer-readable medium, among other materials, are disclosed for generating customized reading materials tailored to students. The system includes processors configured to prompt a user to select subsets of phonemes and corresponding graphemes. Based on these selections, the system identifies or constructs a set of words containing only the selected phonemes and graphemes, excluding unselected ones, and generates phrases or sentences for student practice. Real-time feedback on pronunciation may be provided through word and phoneme-level scoring. The system may leverage a pre-indexed phoneme-grapheme database or rule-based word construction, using dynamic filtering and efficient querying techniques for adaptability and scalability. This approach facilitates individualized instruction by aligning reading materials with each student's developmental needs to improve decoding accuracy and promote reading fluency.

### CROSS-REFERENCE TO RELATED APPLICATION

This application claims the benefit of U.S. provisional application Ser. No. 63/604,066, filed Nov. 29, 2023, the disclosure of which is hereby incorporated in its entirety by reference herein.

### TECHNICAL FIELD

The present disclosure relates to educational technology and adaptive learning systems, particularly to systems and methods for teaching phonics and reading skills using computational tools.

### BACKGROUND

A phoneme is the smallest unit of sound in a language that can differentiate meaning between words. It is an abstract representation of a sound and serves as a fundamental building block of spoken language. Phonemes are not tied to how a sound is written; instead, they represent the sounds themselves. For instance, the word bat contains three phonemes: /b/, /æ/, and /t/. If the phoneme /b/ is replaced with /k/, the word becomes cat, altering its meaning entirely. English has approximately 44 phonemes, depending on the dialect, and these are categorized into consonant phonemes, such as /b/, /t/, and /s/, and vowel phonemes, such as /æ/ (as in bat), /i:/ (as in see), and /Λ/ (as in cup). Phonemes are further distinguished by features such as voicing (whether vocal cords vibrate), place of articulation (e.g., lips, teeth, or throat), and manner of articulation (e.g., stop, fricative, or nasal).

A grapheme is the smallest unit of writing in a language that represents a phoneme. It is a visual symbol, such as a letter or a group of letters, used to encode the sounds of speech. In the English writing system, graphemes include the 26 letters of the alphabet, but their relationship to phonemes is often irregular due to the complexities of English spelling. A single grapheme can represent different phonemes depending on the context, and a single phoneme can be represented by multiple graphemes. For example, the phoneme /f/ can be represented by the grapheme “f” in fun, “ph” in phone, or “gh” in enough. Conversely, the grapheme “x” represents two phonemes, /k/ and /s/, when it appears in a word like box. In some cases, multiple graphemes combine to represent a single phoneme, as seen in the digraph “sh” for /∫/ in ship or the trigraph “tch” for /t∫/ in catch.

The relationship between phonemes and graphemes is fundamental to understanding how spoken language is encoded into writing and how written words are decoded into speech. However, this relationship in English is particularly complex due to the language's deep orthography, which results from its historical borrowing from many other languages. For example, the phoneme /u:/ can be represented by “oo” in moon, “ue” in blue, “ou” in soup, or “u” in flute. These inconsistencies mean that while phonemes provide a consistent way to distinguish sounds in spoken language, the graphemes used to represent those sounds in writing often require specific rules and patterns for interpretation. Ultimately, phonemes are the auditory foundation of language, while graphemes are the written symbols that bring these sounds to life in text.

### SUMMARY

Certain disclosed systems leverage advanced computational techniques to dynamically generate personalized word lists, phrases, and sentences based on user-selected phoneme-grapheme correspondences. The system's architecture may be designed to cater to the specific needs of individual students by providing customized learning materials that align with their developmental stage in word reading and phonics.

In one example, the system includes one or more processors programmed to perform several operations for each of a plurality of students. These operations include generating output to prompt the user (such as a teacher or administrator) to select a subset of phonemes, potentially grouped and displayed according to predefined articulatory gesture categories, such as short vowels, long vowels, R-controlled vowels, or various types of consonants (e.g., stops, nasals, fricatives). The system further allows the user to select corresponding graphemes for each phoneme using an interactive interface. Based on these selections, the system dynamically identifies or constructs a set of words containing only the selected phonemes and graphemes while excluding words with unselected phoneme-grapheme pairs. This ensures that the generated words are aligned with the instructional goals and are different and customized for each student, depending on the phoneme and grapheme subsets chosen for them.

Using the filtered or constructed set of words, the system generates phrases or sentences tailored for display to the student. These phrases and sentences incorporate the selected words to provide meaningful and contextually relevant practice opportunities for decoding and fluency. Additionally, the system may provide real-time feedback by analyzing the student's pronunciation of the words, phrases, or sentences. This analysis is displayed to the user as a score, which may include phoneme-level accuracy, enabling precise tracking of the student's progress and identifying areas needing improvement.

The system may utilize a database of pre-indexed words, with each word mapped to its phonemes and graphemes using the International Phonetic Alphabet (IPA) or other appropriate scheme. It, in some arrangements, dynamically filters this database based on the user's selections, possibly using optimized querying methods for computational efficiency and scalability. Alternative implementations construct the set of words using predefined rules and relationships between phonemes and graphemes. The system can adapt to changes in user input by reprocessing the database in real time to provide updated word lists and instructional materials and promote flexibility and alignment with evolving student needs.

A non-transitory computer-readable medium disclosed herein includes, in some examples, instructions that, when executed by a processor, perform the aforementioned functionalities to enable a system to operate efficiently across a variety of educational environments. Additional features may include grouping and ordering phonemes for display based on their linguistic categories or sequence and providing a scoring mechanism to evaluate the correctness of student pronunciation. The system's design may provide a user pleasant experience for educators and effective learning outcomes for students, promoting individualized instruction and accelerating orthographic mapping and fluency development.

The materials contemplated herein represent an advancement in educational technology by, among other things, addressing the need for personalized, adaptive reading instruction. It also provides a technical solution to the challenge of tailoring educational materials for individual learners, leveraging computational efficiency and innovative design.

### BRIEF DESCRIPTION OF THE DRAWINGS

FIG. 1 is a flow chart of an example algorithm for providing decodable text.

FIG. 2 is a block diagram of an example decodable text system.

### DETAILED DESCRIPTION

Detailed embodiments are provided herein. It is important to note, however, that these embodiments are merely examples and that the described subject matter may take on various alternative forms. The figures included are not necessarily drawn to scale. Certain features may be exaggerated or minimized to better illustrate specific components. Accordingly, the structural and functional details described should not be construed as limiting but rather as illustrative examples intended to guide those skilled in the art in applying the principles described in different ways.

Reading proficiency is a skill that significantly impacts academic achievement and lifelong success. Teaching students to decode words accurately and fluently involves helping them understand the relationships between phonemes (the smallest units of sound) and graphemes (the letters or groups of letters representing those sounds). However, some traditional methods of creating lesson plans for teaching phoneme-grapheme correspondences are labor-intensive and lack the precision necessary to address the individual needs of each student. As a result, educators often struggle to deliver personalized, systematic instruction that adapts to the evolving skills of their students.

Existing lesson creation tools may not provide an efficient way to align instructional content with specific phoneme-grapheme correspondences. These tools often rely on static word lists or generalized frameworks, which do not account for the individual progress or specific learning objectives of each student. Moreover, they may lack mechanisms to dynamically generate content tailored to the phoneme-grapheme mappings selected by the teacher, resulting in inefficiencies and missed opportunities for targeted intervention.

There is a need for a technology-enabled solution that streamlines the process of generating personalized and adaptive reading lessons. Such a system would ideally allow educators to specify phoneme-grapheme correspondences and automatically produce lesson content-including words, phrases, and sentences-that aligns with those selections. Additionally, the system should be capable of adapting in real-time to reflect the student's progress, ensuring that the instructional content remains both challenging and appropriate for their current skill level.

This disclosure addresses these challenges by introducing a computer-implemented system that dynamically generates personalized reading lessons. This system, in some examples, leverages one or more databases of words pre-indexed by phonemes, graphemes, and additional metadata all stored in memory, enabling efficient filtering and selection of lesson content based on user-specified criteria. By incorporating advanced querying techniques and adaptive feedback mechanisms, the system ensures that lesson materials are not only accurate and consistent but also tailored to the unique instructional goals of each educator and the learning needs of each student.

These systems and corresponding algorithms represent a significant advancement over existing methods by providing a technical framework for creating systematic and adaptive lesson plans.

In one example, when a user opens an interface to create a student lesson, they are presented with a set of phonemes arranged into specific groups based on articulatory gestures. These groups are divided into vowels and consonants for clarity and systematic selection. The vowel groups include short vowels (found in closed syllables), long vowels (where the vowel “says its name”), other vowels (including diphthongs and vowel digraphs), and r-controlled vowels. Consonants are categorized into stops, nasals, fricatives, affricates, glides, liquids, and syllabic consonants, following standard phonetic classifications. Each phoneme is accompanied by its International Phonetic Alphabet (IPA) symbol and a keyword to help the user associate the sound with an example word, such as “octopus” for the short/o/vowel sound. Below each phoneme, a list of corresponding graphemes is provided, arranged from most to least frequent in English. Checkboxes allow users to select specific graphemes to include in the lesson.

Once phoneme-grapheme correspondences are selected, the example system generates a list of words and phrases containing the selected sounds. This is accomplished by referencing a database of over 160,000 words, where each word is mapped to its component phonemes. The system filters this database to include only the words that match the selected phoneme-grapheme correspondences. For example, if a teacher selects the short vowels /I/ as in itch, /ε/ as in edge, /æ/ as in apple, /Λ/ as in up, and /α/ as in octopus, as well as long vowels like /i:/ as in equal, /aI/ as in ice, and /eI/ as in day, the filtering process identifies all matching words. Similarly, consonant selections might include stops like /p/, /b/, /t/, /d/, /k/, and /g/, with graphemes limited to “k,” “c,” and “ck” for /k/ and “g” or “gg” for /g/. Fricatives and affricates such as /f/, /v/, /θ/, /ð/, /s/, /z/, and /∫/ may also be selected, but only the graphemes that align with prior instruction are included—for example, /f/ as “f” but not “ph,” and /z/ as “s” but not “z,” “zz,” or “ze.” Additional selections might include nasals like /m/, /n/, and /η/, and liquids and glides like /l/, /r/, and /j/.

A filtering process is then used that excludes any word that contains a phoneme-grapheme correspondence outside the selected set. In one example, a filtered list from the 10,000 most common words in English resulted in 1,437 words and 12 phrases. For students with an existing bank of mastered words, the system further reduces the list by removing known words. The teacher can also supplement the selection with words from “Fry's Instant Word List” or other pre-approved sources. As students progress, the processor continuously adapts the lesson content by integrating previously mastered words, generating increasingly complex words, phrases, and sentences to support the student's decoding and reading fluency.

An example of generated content for a lesson might include phrases like “a black jacket,” “stamping on the bug,” “dropping off a muffin,” “the crab blinks at the man jogging past,” and “the bottomless drinks at Milkman's are the best!” This personalized list ensures that students are practicing with material tailored to their learning needs, combining current lesson content with previously mastered elements to optimize practice. Once the lesson is created, the student logs in to their personalized dashboard, where they are presented with content sequentially: first individual words, then phrases, and finally full sentences. The student reads each aloud, with the system capturing their pronunciation in real-time.

The processor analyzes the accuracy of each phoneme pronounced in the selected words, generating a detailed report on the student's progress. On the teacher's dashboard, a summary score is displayed, reflecting the correctness of the student's pronunciation for each phoneme. This score helps the teacher identify areas of strength and weakness, guiding the planning of future lessons. Each lesson builds cumulatively, revisiting unmastered material while introducing new content. This approach supports decoding accuracy, fluency, and overall reading competence, making every session both prescriptive and adaptive to the student's progress.

The filtering system, in some examples, is designed to work with a database where each word is mapped to its corresponding phonemes and graphemes. This database serves as the foundation for generating customized word lists based on user-selected phoneme-grapheme correspondences. The database includes words indexed with their phonetic breakdowns in the International Phonetic Alphabet (IPA), their grapheme representations, and additional metadata such as word frequency or educational relevance to aid in prioritizing selections. When a user selects specific phonemes and their corresponding graphemes, this input is processed as a set of filtering criteria. For example, a teacher might select the phonemes /k/, /æ/, and /t/ with graphemes “k,” “c,” “ck” for /k/, “a” for /æ/, and “t” for/t.” These criteria determine which words in the database are eligible for inclusion in the filtered list.

The filtering process begins by querying the database for words that match the selected phoneme-grapheme pairs. Each word in the database is checked to ensure that every phoneme in the word aligns with the user's selection and is represented by an approved grapheme. Words containing phonemes or graphemes outside the specified set are excluded. For instance, if the selection specifies /k/ with graphemes “k,” “c,” and “ck,” a word like cat would be included because it aligns with the mappings (/k/=“c,”/æ/=“a,”/t/=“t”), whereas a word like chord would be excluded because it contains “ch” for /k/,” which is not part of the selection. The filtering process ensures that all multi-phoneme words are analyzed thoroughly, rejecting any word where even one phoneme-grapheme pair violates the specified rules. This strict adherence to the filter criteria guarantees that the resulting word list is tailored to the instructional goals and reduces any reading activity on the part of the student not focusing on the work of decoding, such as prediction and context clues.

To manage this process, the system may use optimized database querying methods, such as indexing phoneme-grapheme mappings to enable rapid matching. For each word, the system compares its phoneme and grapheme representations against the filter criteria, excluding non-matching words immediately to streamline computation. The remaining words are compiled into a filtered list, which can then be ranked or sorted based on additional factors such as word frequency or difficulty. For instance, a selection of /I/, /æ/, and /Λ/ for vowels, along with stops like /p/, /b/, /t/, and /k/, would generate a list of words containing only these sounds, such as cat and bat, while excluding words like kite or dog that contain unselected phonemes or graphemes.

This filtering system may also adapt dynamically to user input. When a user modifies their selections, the filter reprocesses the database to generate a new list of words in real time. This ensures that lesson content remains flexible and aligned with the student's learning objectives. To handle large datasets, the system may employ advanced computational techniques, such as multi-threading or caching frequently used filter results, to maintain speed and scalability. Additionally, the filter excludes any words that contain unselected phoneme-grapheme correspondences, making it particularly effective for tailoring content to specific instructional needs. By presenting only words that can be decoded with the phoneme-grapheme correspondences directly taught, the instructional practice increases the number of repetitions needed for orthographic mapping or reading as if by sight.

The system's adaptability extends to lesson creation, where teachers can adjust phoneme-grapheme selections to suit the student's progress. The filter not only generates word lists but also eliminates words that are too advanced for the student's current skill level. By combining strict phoneme-grapheme matching with dynamic filtering and user customization, the system ensures that every lesson is tailored, providing an effective tool for teaching decoding and phonics skills. The resulting personalized word list forms the basis for lesson materials, offering words and phrases that meet the defined criteria and align with the student's phase of word reading development.

Several alternative filtering algorithms can be implemented to potentially enhance the efficiency and flexibility of the system. One approach is a hash-based filtering algorithm, where a hash table is used to map each phoneme or phoneme-grapheme pair to a list of words containing them. When the user selects phonemes and graphemes, the system performs a lookup in the hash table to quickly retrieve all words associated with the selected criteria. For example, if the user selects /k/ with graphemes “k,” “c,” and “ck,” the hash table lookup retrieves matching words like cat and tack. This approach is particularly efficient for large datasets because hash lookups are computationally inexpensive, enabling rapid filtering even for extensive word lists. Additionally, set intersections can be used to combine results for multiple phonemes so that only words matching all criteria are included in the final list.

Another method involves using a trie-based filtering algorithm, where words are stored in a prefix tree (trie) structure, with each level representing a phoneme or grapheme. Filtering involves traversing the trie based on the user-selected phonemes and graphemes. If a user selects /k/, /æ/, and /t/, the system navigates the trie along branches corresponding to these phonemes and their valid graphemes, retrieving words like cat while excluding words like kit (containing the unselected /I/). This hierarchical representation enables efficient filtering and pruning of invalid branches, making it particularly suited for dynamic, multi-step selection processes.

A SQL-based filtering approach uses structured queries to retrieve words from a relational database indexed by phonemes and graphemes. The database can store each word alongside its phonetic and graphemic representations in separate columns. A SQL query filters words based on user-selected criteria using “AND” conditions to ensure inclusion and “NOT IN” conditions to exclude words with unselected phonemes or graphemes. For instance, a query might retrieve words where phonemes are /k/, /æ/, and /t/ and graphemes are limited to “k,” “c,” “a,” and “t,” while excluding words containing “qu” for /k/ or “i” for /I/. This method is adaptable to large-scale datasets and can be integrated into database management systems.

An inverted index filtering algorithm creates a mapping of each phoneme or grapheme to the words they appear in. When the user selects phoneme-grapheme pairs, the system retrieves the corresponding word lists from the inverted index and performs set operations such as intersections to identify words that match all criteria. For example, for the selection /k/, /æ/, and /t/, with graphemes “k,” “c,” and “ck,” the algorithm intersects the lists for each pair to retrieve cat while excluding mismatches like queen.

A bitmask-based filtering algorithm represents phoneme-grapheme mappings for each word as a bitmask, where each bit indicates the presence of a specific phoneme or grapheme. A selection bitmask is generated based on the user input, and filtering is performed using bitwise “AND” operations to include only words matching the selection bitmask. For example, if the selection includes /k/, /æ/, and /t/, only words with these bits set, such as cat, are retained, while words like kite are excluded. This method may be suitable for high-performance applications.

A set-based filtering algorithm treats each word as a set of phoneme-grapheme pairs and the user's selection as another set. Filtering involves computing the intersection of the word's set with the selected set, retaining words where the intersection matches the full selection. For instance, the word cat with the set {(/k/, “c”), (/æ/, “a”), (/t/, “t”)} matches the selected set, while kit with {(/k/, “k”), (/I/, “i”), (/t/, “t”)} does not. This approach may be particularly intuitive for handling dynamic selection criteria.

A machine-learning-based filtering algorithm can be used to classify whether a word matches the selected phoneme-grapheme pairs. A machine-learning model, such as a decision tree or neural network, can be pre-trained on a dataset of phoneme-grapheme mappings. When filtering, the model evaluates each word and predicts whether it satisfies the user's selection. For example, the model might predict that cat matches the selection {(/k/, “c”), (/æ/, “a”), (/t/, “t”)} while excluding queen. This approach may be beneficial for handling complex or nuanced filtering criteria that involve patterns beyond direct phoneme-grapheme matches.

As an alternative to filtering, English word construction based on rules of phoneme and grapheme correspondence can be systematically approached using a combination of linguistic principles and computational automation. Phonemes, the smallest units of sound in language, map to graphemes, the letters or combinations of letters that represent these sounds. This relationship is complex in English due to its deep orthography as suggested earlier, where a single phoneme can correspond to multiple graphemes, and the same grapheme can represent different phonemes depending on context. For example, the phoneme /k/ can be represented by “c,” “k,” or “ck” as suggested above depending on its position within a word, as in cat, kite, or back. Conversely, the grapheme “c” can represent the phoneme /k/ in cat or /s/ in city. To build words programmatically, these relationships can be codified into detailed rules that guide the selection of graphemes based on phonemes, phonotactic constraints, and positional factors. Phonotactic rules, in particular, are for ensuring that phoneme sequences are permissible within English. They dictate which combinations of sounds are valid, such as allowing /str/ at the start of a word, as in street, but prohibiting combinations like /zb/ or /vn/ in the same position. These rules also account for restrictions on the placement of specific sounds, such as /η/, which is permissible as a coda in sing but not as an onset in any native English word. Automation of this step involves designing rule-based or statistical models that can evaluate the legality of a phoneme sequence within a specified word or syllable structure.

The process of constructing words begins with defining phoneme-to-grapheme mappings. Each phoneme is associated with one or more graphemes, and the choice of grapheme is influenced by its position in a word, the surrounding phonemes, and orthographic conventions. For instance, the phoneme /i:/ may be represented by “ee,” as in meet, “ea,” as in seat, or “e,” as in mete. Similarly, the /η/ phoneme can be written as “ng” in sing, or “n” in bank. Contextual rules refine these mappings, ensuring that grapheme selection aligns with established orthographic patterns. For example, the grapheme “c” is typically used for /s/ when followed by “e,” “i,” or “y,” as in cell, city, or cycle, but represents /k/ when followed by other vowels or consonants, as in cat or clock. Automation of this module involves building a phoneme-to-grapheme mapping table stored as a database or hash table, allowing rapid lookup of possible graphemes for each phoneme. The system may rank grapheme options by their frequency in English, prioritizing common mappings unless overridden by user preferences or contextual rules.

Phonotactic rules are applied next to ensure phoneme sequences form plausible English syllables. These rules regulate which sounds can occur together, their order, and their placement within syllables. For instance, in English, the cluster /pl/ is valid as an onset, as in play, but /lp/ cannot serve as an onset and only appears as a coda, as in help. The structure of syllables is guided by templates such as consonant-vowel-consonant (CVC), consonant-vowel (CV), or more complex forms like CCVCC. These templates dictate the arrangement of consonants and vowels within each syllable. Phonotactic constraints also extend to vowel-consonant transitions across syllables in multi-syllable words, ensuring smooth transitions and natural sound patterns. The automation of this step involves creating a rule engine or phonotactic checker that validates sequences against predefined rules for syllable legality. This system could employ finite-state automata, where each state represents a valid phoneme cluster, and transitions enforce rules about what sounds can follow each other.

To construct words with multiple syllables, the process involves layering syllable templates together, generating each syllable independently, and combining them into a cohesive structure. Each syllable is crafted based on its phoneme sequence and phonotactic rules, while transitions between syllables are refined to maintain naturalness. For example, the two-syllable word matter can be created using the phonemes /m/, /æ/, /t/, and / [symbol] r/. The first syllable, /m/, /æ/, /t/, is structured as CVC or a closed syllable, with /m/ mapped to “m,” /æ/ to “a,” and /t/ to “t,” forming “mat.” The second syllable, / [symbol] r/, is an r-controlled syllable and corresponds to the grapheme “er,” completing the word. In English, there are only 6 syllable types: closed, open, r-controlled, vowel team, vowel-consonant-e, and final stable syllable. While the need for extended explicit instruction of these is under scrutiny, the impact of the structure of syllable affects pronunciation. In a three-syllable word like ‘complicate’, the first syllable is formed by combining a closed syllable, ‘com’, an open syllable, ‘pli’, and a vowel-consonant-e syllable, ‘cate’. Automating this involves sequentially applying the syllable templates, with each module generating and validating individual syllables before assembling them into a complete word. The system could also incorporate a stress pattern module that assigns primary or secondary stress to syllables, influencing vowel length or grapheme choice. This would help with the stress shifts in words like ge-og'ra-phy to ge'o-graph'ic-al. In this example, while morphology, or word meaning, plays a role in the spelling and meaning of the words, the phonetics of syllable structures underlie pronunciation.

Automating the overall process may require a modular architecture, where each module performs a specific task and feeds its results into subsequent stages. The first module defines phoneme-to-grapheme mappings, implemented as a lookup table or relational database. This module may include a scoring system to rank grapheme options based on frequency, context, and user preferences. The second module enforces phonotactic constraints, using rule-based systems or machine-learning models trained on a corpus of valid English words. Another module applies syllable templates, grouping phonemes into valid structures while accounting for phonotactic rules. The syllable generation module might integrate algorithms for constructing onset, nucleus, and coda components based on predefined rules or statistical models.

Once syllables are generated, a word-construction module assembles them into a complete word, applying inter-syllabic phonotactic rules and stress patterns. This module might use a finite-state machine or probabilistic language model to handle transitions between syllables, ensuring smooth combinations. A validation module checks the generated word against a database of known English words or applies statistical models to estimate plausibility. If a word fails validation, the system can iterate by selecting alternative graphemes, adjusting phoneme sequences, or modifying syllable templates. This iterative refinement ensures that generated words adhere to linguistic norms while accommodating variability in input constraints.

Morphophonemic rules are integrated to handle changes at word boundaries, such as pluralization, tense shifts, or suffix addition. For instance, adding the plural suffix “-s” to a word depends on the final phoneme of the root word. If the root ends in a voiceless consonant like /k/, the suffix is pronounced as /s/, as in cats. If the root ends in a voiced consonant like /d/, the suffix is pronounced as /z/, as in dogs. For roots ending in sibilants like /s/ or /∫/, an additional vowel is inserted, yielding /Iz/, as in buses or wishes. Automating this involves a suffix application module that uses phoneme context to determine morphological transformations. The module could be driven by decision trees or rule-based logic, dynamically altering word forms to match English phonological patterns. By integrating these automated processes into a cohesive system, the platform can dynamically generate valid and linguistically accurate English words based on user-defined phoneme and grapheme inputs.

As mentioned above, once a word bank is formed from words deemed to be known-whether identified by the student, teacher, or an automatic speech recognition and analysis platform—these words, along with any other approved words, can be utilized as input for a large language model (LLM), a generative artificial intelligence (AI) system, or the like. This process involves a comprehensive technical framework designed to ensure that the output aligns with the educational goals of personalized reading practice.

First, the words from the word bank are preprocessed and encoded into a format compatible with the input requirements of the LLM. This preprocessing may include tokenization, embedding the words into vector representations, and adding metadata tags to each word. Metadata can specify attributes such as phoneme-grapheme correspondences, word frequency, difficulty level, or contextual relevance. Approved additional words are similarly encoded and combined with the word bank to form a comprehensive input set.

Next, this input is fed into the LLM or generative AI system, which may have been pre-trained on extensive text corpora. The system may be configured with constraints to ensure the generated phrases or sentences align with the desired phoneme-grapheme patterns, syntactic structures, and semantic relevance for the student's learning level. These constraints may include specifying particular phonemes or graphemes to appear in the output, controlling sentence complexity, or enforcing thematic coherence aligned with the lesson plan.

For example, the system can use prompt engineering to guide the LLM to generate sentences incorporating specific words while maintaining a pedagogically appropriate structure. A prompt might be designed to instruct the model to form sentences containing a mix of short and long vowels or specific consonant sounds. Additionally, the generative AI can be programmed to exclude words that fall outside the student's current level of mastery or violate the specified phoneme-grapheme correspondences, ensuring adherence to the instructional goals.

The system can also leverage techniques such as beam search or temperature scaling during the generation process to produce high-quality outputs that are both grammatically correct and contextually appropriate. Once generated, the output undergoes post-processing to validate its alignment with the educational criteria. This may include automated checks for phoneme-grapheme correspondence accuracy, readability assessments, and compliance with the student's learning objectives. The validated phrases and sentences are then integrated into the lesson materials for practice.

By incorporating this technical framework, the system ensures that phrases and sentences generated by the LLM, or generative AI are not only tailored to the specific phoneme-grapheme mappings selected but also enhance the student's reading practice through contextualized and meaningful content. This approach leverages the capabilities of generative AI to provide personalized, adaptive, and engaging practice material, addressing the limitations of static, pre-formed lesson content and significantly advancing the efficacy of reading instruction.

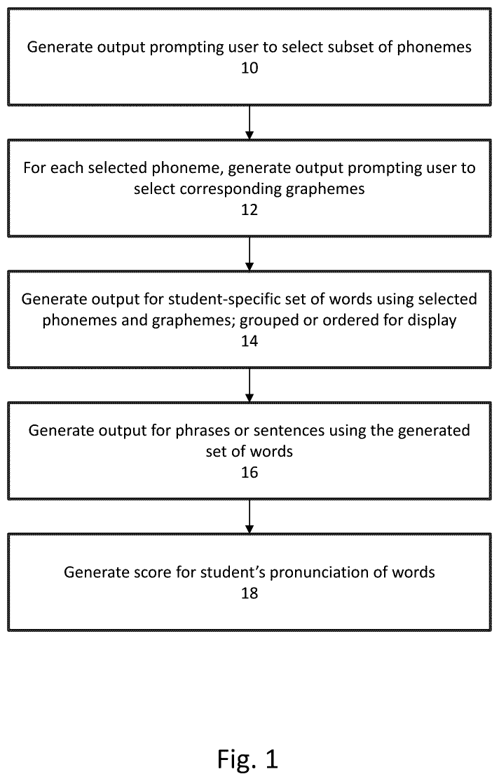

Referring to FIG. 1, the process begins with operation 10, where the system generates output prompting the user to select a subset of phonemes. This step allows the teacher or administrator to choose specific phonemes from a categorized display. The phonemes are grouped into categories such as short vowels (/æ/ in cat or /ε/ in edge), long vowels (/eI/ in cake), and consonants categorized as stops (/p/, /t/), nasals (/m/, /n/), and fricatives (/f/, /s/). The phonemes may also be displayed in an ordered sequence, such as short vowels first, followed by long vowels, and so on. For example, the system might display the phoneme /æ/ with its corresponding keyword example, “apple,” to aid in the selection process. This organization ensures that teachers can efficiently target specific phonemes based on the student's learning objectives.

At operation 12, the system generates output prompting the user to select at least one corresponding grapheme for each selected phoneme. For instance, if the user selects the phoneme /k/, the system provides grapheme options such as “k,” “c,” or “ck,” and allows the user to specify which graphemes to include. This step ensures that the words generated later reflect the spelling patterns the teacher intends to emphasize. The process is dynamic, updating grapheme options based on the selected phonemes. For example, if the teacher selects /æ/ as in “apple,” the system ensures that words with “a” representing /æ/ are included in the lesson, while excluding other grapheme representations not selected by the teacher.

Operation 14 involves generating output for a student-specific set of words using the selected phonemes and graphemes. At this stage, the system references a database containing words mapped to their phonemes and graphemes. The system filters the database to identify words that exclusively contain the selected phonemes and corresponding graphemes. For example, if the user selects /æ/, /k/, and /t/, the system might generate words like cat, tack, or act, while excluding words like kit (which includes the unselected /I/) or queen (which includes the unselected grapheme “qu”). This filtering process ensures that the word sets generated are customized for the student and align with the instructional goals.

Operation 16 extends the functionality by generating output for phrases or sentences using the filtered set of words. This step creates meaningful contexts for students to practice reading. For example, if the filtered set includes words like ‘cat, bat, and rat,’ the system might generate phrases such as ‘a black cat’ or sentences like ‘The cat sat on the mat.’ By incorporating the selected words into phrases or sentences, the system helps students practice not only decoding but also understanding how the words function in a broader linguistic context. This step enhances both decoding skills and comprehension.

Operation 18 concludes the process by generating a score for the student's pronunciation of the words. As the student reads the words, phrases, or sentences aloud, the system captures their pronunciation in real time and analyzes the accuracy. This analysis evaluates specific phonemes within each word, providing detailed feedback on whether the student articulated each phoneme correctly. For example, if the student reads the word cat, the system evaluates the correctness of their articulation of /k/, /æ/, and /t/, and generates a score that reflects their performance. This feedback is displayed to the teacher in a summarized format, helping them identify areas where the student excels and areas that need further practice. The detailed scoring system provides actionable insights that guide the planning of future lessons.

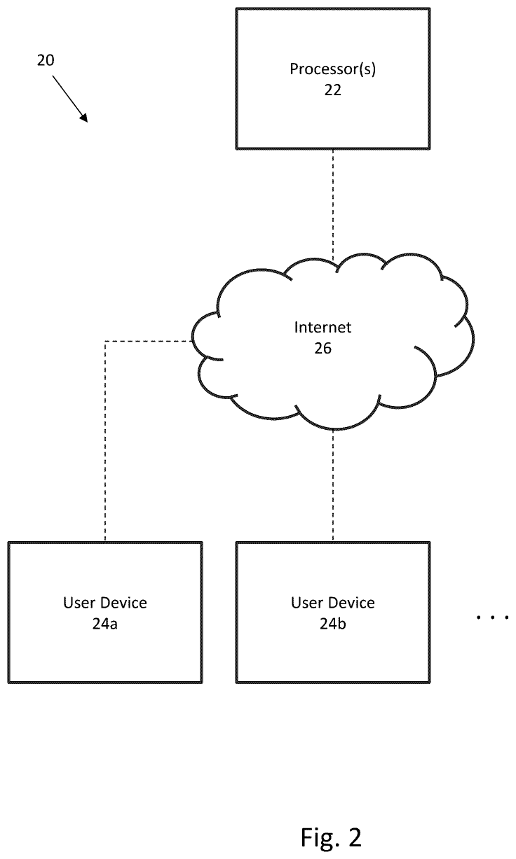

Referring to FIG. 2, an example decodable text system 20 includes one or more processors 22 and user devices 24a, 24b, etc. (e.g., cell phone, tablet, laptop, etc.) These components may be in communication with each other via Internet 26 and/or other network and may alone or in combination implement the algorithms contemplated herein.

The algorithms, methods, or processes described herein can be implemented by or delivered to a computer, controller, or processing device. These devices may include any dedicated or programmable electronic control unit. The algorithms, methods, or processes can be stored as executable instructions in various forms, including but not limited to information permanently stored on non-writable storage media (e.g., read-only memory devices), or information alterably stored on writable storage media (e.g., compact discs, random access memory devices, or other magnetic and optical media). Additionally, these algorithms, methods, or processes can be executed as software objects or embodied entirely or partially in hardware components, such as application-specific integrated circuits (ASICs), field-programmable gate arrays (FPGAs), state machines, or other hardware devices. A combination of firmware, hardware, and software components may also be used to achieve the described functionality.

While the embodiments described above are exemplary, they are not intended to encompass all possible variations covered by the claims. The terminology used in this specification serves as a means of description rather than limitation. It should be understood that various modifications can be made without departing from the essence or scope of the disclosed materials.

As previously noted, features from different embodiments may be combined to create additional embodiments that are not explicitly described or illustrated. While some embodiments may be described as offering advantages or being preferred over other embodiments or prior art implementations with respect to certain characteristics, those skilled in the art recognize that trade-offs may be necessary to achieve desired overall system attributes. Therefore, embodiments described as less favorable in certain respects may still fall within the scope of this disclosure and may be particularly well-suited for specific applications.

What is claimed is:

1. An individualized decodable text system comprising:
one or more processors programmed to, for each of a plurality of students, (i) generate output, for display to a user, prompting the user to select a subset of phonemes, (ii) for each member of the subset, generate output, for display to the user, prompting the user to select at least one corresponding grapheme, (iii) generate output, for display to the student, identifying a set of words that contain only the subset of phonemes and the selected at least one corresponding graphemes, and not the other of the phonemes, such that for different subsets of phonemes among the students the sets of words are different among the students and customized for each of the students, and (iv) using at least some of the set of words, generate output, for display to the student, indicative of a phrase or sentence that contains the at least some of the set of words.

2. The individualized decodable text system of claim 1, wherein the one or more processors are further programmed to, for each of the plurality of students, filter a pre-indexed database of words according to the subset of phonemes and the selected at least one corresponding graphemes to identify the set of words.

3. The individualized decodable text system of claim 1, wherein the one or more processors are further programmed to, for each of the plurality of students, construct the set of words using rules, the subset of phonemes, and the selected at least one corresponding grapheme.

4. The individualized decodable text system of claim 1, wherein the one or more processors are further programmed to generate the output, for display to the user, prompting the user to select the subset of phonemes such that that the phonemes are grouped for display according to categories including at least one of short vowels, long vowels, other vowels, R-controlled vowels, consonant stops, consonant nasals, consonants fricatives, consonant affricates, consonant glides, consonant liquids, or syllabic consonants.

5. The individualized decodable text system of claim 1, wherein the one or more processors are further programmed to generate the output, for display to the user, prompting the user to select the subset of phonemes such that that the phonemes are grouped and ordered for display according to the following sequence: short vowels, long vowels, other vowels, R-controlled vowels, consonant stops, consonant nasals, consonants fricatives and consonant affricates, consonant glides and consonant liquids, and syllabic consonants.

6. The individualized decodable text system of claim 1, wherein the one or more processors are further programmed to generate output, for display to the user, indicating a score associated with a pronunciation by the student for each of the words of the set.

7. The individualized decodable text system of claim 6, wherein the score indicates a correctness of the pronunciation of one of the phonemes of the word.

8. The individualized decodable text system of claim 1, wherein the one or more processors are further programmed to, for each member of the subset of phonemes, generate output, for display to the user, prompting the user to select at least one corresponding grapheme responsive to input identifying a member of the subset.

9. A non-transitory computer readable medium having instructions thereon that, when executed by a processor, cause the processor to, for each of a plurality of students, (i) generate output, for display to a user, prompting the user to select a subset of phonemes, (ii) for each member of the subset, generate output, for display to the user, prompting the user to select at least one corresponding grapheme, (iii) generate output, for display to the student, identifying a set of words that contain only the subset of phonemes and the selected at least one corresponding graphemes, and not the other of the phonemes, such that for different subsets of phonemes among the students the sets of words are different among the students and customized for each of the students, and (iv) using at least some of the set of words, generate output, for display to the student, indicative of a phrase or sentence that contains the at least some of the set of words.

10. The non-transitory computer readable medium of claim 9 further having instructions thereon that, when executed by the processor, cause the processor to, for each of the plurality of students, filter a pre-indexed database of words according to the subset of phonemes and the selected at least one corresponding grapheme to identify the set of words.

11. The non-transitory computer readable medium of claim 9 further having instructions thereon that, when executed by the processor, cause the processor to, for each of the plurality of students, construct the set of words using rules, the subset of phonemes, and the selected at least one corresponding grapheme.

12. The non-transitory computer readable medium of claim 9 further having instructions thereon that, when executed by the processor, cause the processor to generate the output, for display to the user, prompting the user to select the subset of phonemes such that that the phonemes are grouped for display according to categories including at least one of short vowels, long vowels, other vowels, R-controlled vowels, consonant stops, consonant nasals, consonants fricatives, consonant affricates, consonant glides, consonant liquids, or syllabic consonants.

13. The non-transitory computer readable medium of claim 9 further having instructions thereon that, when executed by the processor, cause the processor to generate the output, for display to the user, prompting the user to select the subset of phonemes such that that the phonemes are grouped and ordered for display according to the following sequence: short vowels, long vowels, other vowels, R-controlled vowels, consonant stops, consonant nasals, consonants fricatives and consonant affricates, consonant glides and consonant liquids, and syllabic consonants.

14. The non-transitory computer readable medium of claim 9 further having instructions thereon that, when executed by the processor, cause the processor to generate output, for display to the user, indicating a score associated with a pronunciation by the student for each of the words of the set.

15. The non-transitory computer readable medium of claim 14, wherein the score indicates a correctness of the pronunciation of one of the phonemes of the word.

16. The non-transitory computer readable medium of claim 9 further having instructions thereon that, when executed by the processor, cause the processor to, for each member of the subset of phonemes, generate output, for display to the user, prompting the user to select at least one corresponding grapheme responsive to input identifying a member of the subset.
